(19) United States
(12) Patent Application Publication
(10) Pub. No.: US 2026/0276139 A1
(43) Pub. Date: Sep. 17, 2026

(54) DUAL-LOCK SUPPORT ASSEMBLY AND PHOTOGRAPHY SUPPORT FRAME

(71) Applicant: SHENZHEN LEQI INNOVATION CO., LTD., SHENZHEN (CN)

(72) Inventors: LIANG GUO, SHENZHEN (CN); SHAORUI TANG, SHENZHEN (CN); JIANLEI ZHANG, SHENZHEN (CN)

(21) Appl. No.: 19/565,612

(22) Filed: Mar. 13, 2026

(30) Foreign Application Priority Data
Mar. 14, 2025 (CN) 202520456757.5

(51) Int. Cl. F16M 11/32; F16M 11/04; G03B 17/56

(52) U.S. Cl. CPC F16M 11/32; F16M 11/041; G03B 17/561; F16M 2200/027

(57) ABSTRACT

The present disclosure provides a dual-lock support assembly and a photography support frame. The dual-lock support assembly includes a telescopic tube assembly including an outer tube, a first inner tube and a second inner tube being capable of sliding relative to the outer tube, and the second inner tube is capable of sliding relative to the first inner tube. The support assembly further includes a first locking assembly which includes a first connecting member connected to the outer tube; a locking sleeve sleeved with the first connecting member, the locking sleeve is arranged with a first abutting portion, an inner wall of the first abutting portion abuts against the second inner tube, a gap is formed between the first abutting portion and the locking sleeve; and a second connecting member connected to the first inner tube, a side wall of the second connecting member extends into the gap.

### CROSS-REFERENCE TO RELATED APPLICATION

This application is based on and claims priority to China Patent Application No. 2025204567575, filed on Mar. 14, 2025, the entire contents of which are incorporated herein by reference.

### FIELD

The present disclosure relates to the technical field of photographic and videographic equipment, especially relates to a dual-lock support assembly and a photography support frame.

### BACKGROUND

With increased demand for photography and video creation, various types of photographic auxiliary equipment have emerged continuously. As one of the common photographic auxiliary devices, the photography support frame can provide stable support for a camera or other shooting devices to reduce image shake caused by hand-holding or unstable platforms, thereby improving shooting quality.

Currently, common photography support frames on the market include monopods, tripods, and some dedicated support structures. These frames typically achieve overall extension and retraction through several support assemblies, providing stable support at multiple angles and heights during shooting. These support assemblies are generally composed of multi-section rods, which allow height or angle adjustment through telescoping between sections. To ensure the stability of the support assemblies during use, it is usually necessary to install locking assemblies between each rod section.

However, the locking assemblies in the related art have the following disadvantages. The locking assemblies can only implement a single locking mode. Even when locking a same pair rods, locking force can only be generated on a single contact surface or in a single direction, lacking a multi-level safety mechanism, resulting in prone to loosening when subjected to heavy loads or vibrations.

### SUMMARY

The main purpose of the present disclosure is to propose a dual-lock support assembly, aiming to provide a multifunctional locking and unlocking mode.

To achieve the above purpose, the present disclosure proposes a dual-lock support assembly which includes a telescopic tube assembly. The telescopic tube assembly includes an outer tube and a first inner tube arranged inside the outer tube and capable of sliding axially relative to the outer tube in an axial direction. The telescopic tube assembly further includes a second inner tube arranged inside the first inner tube and capable of sliding axially relative to the first inner tube in the axial direction.

The dual-lock support assembly further includes a first locking assembly. Wherein the first locking assembly includes:

a first connecting member connected to one end of the outer tube;

a locking sleeve, one end of the locking sleeve sleeved with the first connecting member, and another end of the locking sleeve being disposed with a first abutting portion, and the first abutting portion being disposed within the locking sleeve. An inner wall of the first abutting portion abutting against an outer wall of the second inner tube, and a gap is formed between an outer wall of the first abutting portion and an inner wall of the locking sleeve;

a second connecting member connected to one end of the first inner tube, a side wall of the second connecting member extending into the gap.

In some embodiments, an outer wall of the first connecting member is arranged with external threads, and an inner wall of the locking sleeve is arranged with internal threads configured to engage with the external threads. The locking sleeve is threadedly connected to the first connecting member via engagement of the external threads and the internal threads.

In some embodiments, both an outer wall of the first abutting portion and an inner wall of the second connecting member are tapered.

In some embodiments, an inner wall of the locking sleeve defines an annular groove, the annular groove is located at an end of the locking sleeve remote from the second connecting member; and an end of the first abutting portion remote from the second connecting member is disposed with a mounting protrusion, the mounting protrusion is in clamping in the annular groove.

In some embodiments, the dual-lock support assembly further includes:

a third inner tube arranged inside the second inner tube;

a fourth inner tube arranged inside the third inner tube;

a second locking assembly connected to one end of the second inner tube and one end of the third inner tube and sleeved outside the fourth inner tube, wherein the second locking assembly is identical in structure to the first locking assembly.

In some embodiments, the dual-lock support assembly further includes:

a first driving assembly arranged at another end of the outer tube, an execution end of the first driving assembly extends into the outer tube and connects to another end of the second inner tube;

the first driving assembly includes a mounting shell defining a first cavity, a first opening and a second opening are respectively disposed at two ends of the first cavity, both the first opening and the second opening are connected to the first cavity, and the first driving assembly further includes a piston assembly which is disposed within the first cavity, the piston assembly includes a piston rod which is configured to pass through the first opening, the first cavity, and the second opening in sequence, an outer peripheral wall of the piston rod being provided with a partition member configured to divide the first cavity into at least two chambers; wherein a fluid channel fluid channel is defined inside the piston rod, one end of the fluid channel is communicated with the outside, and another end of the fluid channel extends into a side wall of the piston rod and communicates with one of the at least two chambers.

In some embodiments, the first driving assembly further includes an elastic member mounted in the other one of the at least two chambers and configured to support the piston rod.

In some embodiments, the dual-lock support assembly further includes:

a second driving assembly arranged at another end of the second inner tube, an execution end of the second driving assembly extends into the second inner tube and connects to another end of the third inner tube, the second driving assembly is configured to drive the third inner tube to move axially relative to the second inner tube; wherein the second driving assembly is identical in structure to the first driving assembly.

In some embodiments, both the first driving assembly and the second driving assembly are hydraulic cylinders, and the first driving assembly is connected to the second driving assembly via a fluid channel.

The present disclosure also proposes a photography support frame, which includes an operating component, a bearing base, and a plurality of dual-lock support assemblies according to the aforementioned embodiments. The bearing base is connected to the telescopic tube assemblies of the plurality of support assemblies, and the bearing base is configured to mount photographic equipment.

The operating component is connected to the first driving assembly and the second driving assembly of each the support assembly, and the operating component is configured to output a driving force to the first driving assembly and the second driving assembly of each of the support assemblies.

In the technical solution of the present disclosure, by inserting the second connecting member into the gap between the outer wall of the first abutting portion and the inner wall of the locking sleeve, a dual-locking mechanism is formed. On one hand, the outer wall of the second connecting member abuts against the inner wall of the locking sleeve, and the inner wall of the second connecting member abuts against the outer wall of the first abutting portion, achieving a first-level lock and effectively restricting the axial movement of the first inner tube relative to the outer tube. On the other hand, the inner wall of the first abutting portion tightly abuts against the outer wall of the second inner tube, generating sufficient friction to form a second-level lock, ensuring that the second inner tube does not slide unintentionally during use. Such a dual-locking structure ensures the overall stability and load-bearing capacity of the support assembly.

### BRIEF DESCRIPTION OF THE DRAWINGS

Implementations of the present disclosure will now be described, by way of embodiment, with reference to the attached FIG.s. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic view of an overall structure of a dual-lock support assembly according to an embodiment of the present disclosure.

FIG. 2 is a front view of the dual-lock support assembly according to an embodiment of the present disclosure.

FIG. 3 is a cross-sectional view of the dual-lock support assembly taken along line A-A in FIG. 2.

FIG. 4 is another cross-sectional view of the dual-lock support assembly from different perspective of FIG. 2.

FIG. 5 is an enlarged view of portion B in FIG. 4.

FIG. 6 is an exploded view of a first locking assembly according to an embodiment of the present disclosure.

FIG. 7 is an enlarged view of portion C in FIG. 4.

FIG. 8 is an enlarged view of portion D in FIG. 4.

FIG. 9 is an exploded view of a first driving assembly according to an embodiment of the present disclosure.

FIG. 10 is an enlarged view of portion E in FIG. 4.

FIG. 11 is a schematic view of an overall structure of a photography support frame according to an embodiment of the present disclosure.

### REFERENCE NUMERALS

100, telescopic tube assembly; 101, outer tube; 102, first inner tube; 103, second inner tube; 210, first locking assembly; 211, first connecting member; 212, locking sleeve; 212a, annular groove; 213, first abutting portion; 213a, mounting protrusion; 214, second connecting member; 215, gap; 104, third inner tube; 105, fourth inner tube; 220, second locking assembly; 300, first driving assembly; 301, mounting shell; 301a, first cavity; 301b, first opening; 301c, second opening; 301d, execution end; A1, first chamber; A2, second chamber; 302, piston assembly; 303, piston rod; 304, partition member; 303a, fluid channel; 305, elastic member; 400, second driving assembly; 401, execution end; 500, photography support frame; 501, operating component; 502, bearing base.

The realization of the aim, functional characteristics, advantages of the present disclosure are further described with reference to the accompanying drawings and embodiments.

### DETAILED DESCRIPTION

The technical solutions in the embodiments of the present disclosure will be clearly and completely described below in conjunction with the accompanying drawings in the embodiments of the present disclosure. It is obvious that the described embodiments are only part of the embodiments of the present disclosure, not all of them. Based on the embodiments of the present disclosure, all other embodiments obtained by those of ordinary skill in the art without creative work shall fall within the scope of protection of the present disclosure.

It should be noted that all directional indications (such as up, down, left, right, front, back, etc.) in the embodiments of the present disclosure are only used to explain the relative positional relationship, movement conditions, etc., between the components under a specific posture (as shown in the accompanying drawings). If the specific posture changes, the directional indications will also change accordingly.

It should also be noted that when an element is referred to as being “fixed to” or “disposed on” another element, it can be directly on the other element or there may be an intervening element. When an element is referred to as being “connected to” another element, it can be directly connected to the other element or there may be an intervening element.

In addition, descriptions involving “first”, “second”, etc., in the present disclosure are for descriptive purposes only and shall not be construed as indicating or implying their relative importance or implicitly indicating the number of indicated technical features. Thus, features defined with “first”, “second” may explicitly or implicitly include at least one such feature. In addition, the technical solutions of the various embodiments can be combined with each other, but must be based on the realization by those of ordinary skill in the art. When a combination of technical solutions is contradictory or cannot be realized, it shall be considered that such a combination of technical solutions does not exist and is not within the scope of protection claimed by the present disclosure.

In application fields requiring height-adjustable support equipment, such as photography and drawing board support, telescopic support assemblies are widely used. However, locking mechanisms in the related art commonly have complicated structures and a large number of components, which not only increase production costs but also raise assembly difficulty and failure rates. In addition, the locking effect of conventional locking structures is unsatisfactory which prone lead to loosening, affecting operational safety and stability. Therefore, the present disclosure proposes a dual-lock support assembly with a simple structure and reliable locking effect to solve the above technical problems. The present embodiment is described by taking a support assembly of a photographic tripod as an example.

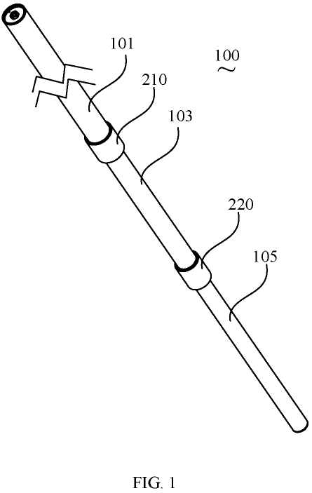

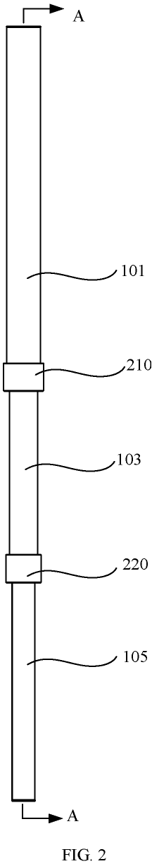

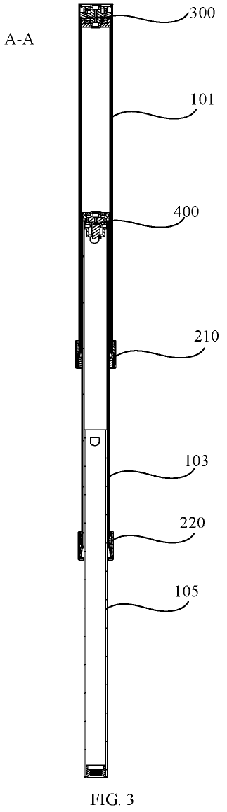

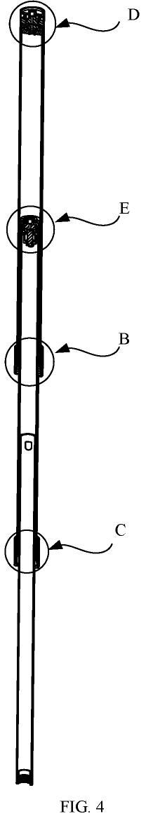

With reference to FIGS. 1 to 5, an embodiment of the present disclosure provides a dual-lock support assembly. The dual-lock support assembly includes a telescopic tube assembly 100.

The telescopic tube assembly 100 includes an outer tube 101, a first inner tube 102 disposed within the outer tube 101, and a second inner tube 103 disposed within the first inner tube 102. The first inner tube 102 is capable of sliding relative to the outer tube 101 in an axial direction, and the second inner tube 103 is capable of sliding relative to the first inner tube 102 in the axial direction. The support assembly further includes a first locking assembly 210, and the first locking assembly 210 includes a first connecting member 211, and a locking sleeve 212, and a second connecting member 214.

The first connecting member 211 is connected to one end of the outer tube 101.

One end of the locking sleeve 212 is nested with the first connecting member 211, the other end of the locking sleeve 212 is provided with a first abutting portion 213, and the first abutting portion 213 is coaxially disposed within the locking sleeve 212. An inner wall of the first abutting portion 213 abuts against an outer wall of the second inner tube 103, and a gap 215 is defined between an outer wall of the first abutting portion 213 and an inner wall of the locking sleeve 212.

The second connecting member 214 is connected to one end of the first inner tube 102, and a side wall of the second connecting member 214 extends into the gap 215.

In the present embodiment, the telescopic tube assembly 100 functions to achieve flexible adjustment of the support assembly’s height to meet requirements of different usage scenarios. The telescopic tube assembly 100 may adopt a multi-stage telescopic structure, including an outer tube 101, a first inner tube 102 disposed within the outer tube 101, and a second inner tube 103 disposed within the first inner tube 102. The first inner tube 102 is capable of sliding relative to the outer tube 101 in an axial direction, and the second inner tube 103 is capable of sliding relative to the first inner tube 102 in the axial direction, thus achieving stepwise height adjustment through relative movement of the tubes. It can be understood that the present embodiment is described merely by taking the outer tube 101, the first inner tube 102, and the second inner tube 103 as an example. In other embodiments, more tubes may be provided, such as a third inner tube 104, a fourth inner tube 105, etc., so as to achieve a broader range of height adjustment and finer adjustment precision.

The first locking assembly 210 in the present embodiment functions to fix relative positions between the tubes at all stages and prevent relative sliding during use. The first locking assembly 210 includes a first connecting member 211, a locking sleeve 212, and a second connecting member 214. Locking is mainly achieved by the second inner tube 103 driving the second connecting member 214 to extend into or disengage from the gap 215 between the outer wall of the first abutting portion 213 and the inner wall of the locking sleeve 212, so as to realize locking or unlocking. The first connecting member 211 is fixedly connected to one end of the outer tube 101 to provide basic support for the entire locking assembly. One end of the locking sleeve 212 is nested with the first connecting member 211, and the other end is arranged with a first abutting portion 213. The first abutting portion 213 is coaxially disposed within the locking sleeve 212, an inner wall of the first abutting portion 213 abuts against the outer wall of the second inner tube 103, and an outer wall of the first abutting portion 213 and the inner wall of the locking sleeve 212 cooperatively defines the gap 215. The second connecting member 214 is connected to one end of the first inner tube 102, and a side wall of the second connecting member 214 extends into the above gap 215.

In an actual usage scenario, taking a photographic tripod as an example, when the tripod height needs to be adjusted, an unlocking operation is first required. During the unlocking process, a user may operate a driving assembly to realize movement of the first inner tube 102. For example, the driving assembly drives the first inner tube 102 to move in a first direction (e.g., upward), thereby driving the second connecting member 214 to disengage from the gap 215 between the outer wall of the first abutting portion 213 and the inner wall of the locking sleeve 212, so as to realize unlocking. It should be understood that in the present embodiment, the second connecting member 214 does not completely disengage.

Thus, after unlocking, the second inner tube 103 can slide out of the first inner tube 102 under an external force (the external force may be gravity or pushing/pulling force from a user), realizing height adjustment. After a suitable height is found, the operation on the driving assembly is stopped, the driving assembly resets, so as to drive the first inner tube 102 to move in a second direction (e.g., downward), and at this time the second connecting member 214 re-enters the gap 215 between the outer wall of the first abutting portion 213 and the inner wall of the locking sleeve 212.

After the second connecting member 214 is inserted into the gap 215, the outer wall of the second connecting member 214 abuts against the inner wall of the locking sleeve 212, and the inner wall of the second connecting member 214 abuts against the outer wall of the first abutting portion 213, forming a tight engagement state. Such an engagement state effectively restricts the axial movement of the first inner tube 102 relative to the outer tube 101, so that a relatively fixed positional relationship is maintained between the outer tube 101 and the first inner tube 102, thereby realizing a first level of locking.

At the same time, the inner wall of the first abutting portion 213 tightly abuts against the outer wall of the second inner tube 103 to generate sufficient friction. Such an abutting relationship restricts the axial movement of the second inner tube 103 relative to the first inner tube 102, realizing a second level of locking, thereby ensuring that the second inner tube 103 does not slide or sink spontaneously during use.

The technical solution of the present disclosure, by adopting the first locking assembly 210 which is composed of only three main parts of the first connecting member 211, the locking sleeve 212, and the second connecting member 214, making the locking assembly structure simple and compact, which greatly reduces production costs and assembly difficulty. Further, by inserting the second connecting member 214 into the gap 215 between the outer wall of the first abutting portion 213 and the inner wall of the locking sleeve 212, a well-designed dual-locking mechanism is formed. On the one hand, the outer wall of the second connecting member 214 abuts against the inner wall of the locking sleeve 212, and the inner wall of the second connecting member 214 abuts against the outer wall of the first abutting portion 213, forming a first level of locking, which effectively restricts the axial movement of the first inner tube 102 relative to the outer tube 101. On the other hand, the inner wall of the first abutting portion 213 tightly abuts against the outer wall of the second inner tube 103 to generate sufficient friction, forming a second level of locking, ensuring that the second inner tube 103 does not slide spontaneously during use. Such a dual-locking structure ensures the overall stability and load-bearing capacity of the support assembly. In addition, the entire locking and unlocking process can be completed with a single operation, allowing users to effortlessly control the driving assembly to achieve height adjustment and locking, making the operation simple and convenient. Moreover, the first abutting portion 213 and the second inner tube 103 adopt surface contact, which effectively avoids localized wear caused by point contact, prolonging the service life of the product. Such a design is particularly suitable for equipment requiring precise positioning and high load-bearing capacity, such as photographic tripods.

It should be noted that in the present embodiment, the driving of the second inner tube 103 may be realized by using a driving member, and the driving member may be a mechanical or electrical device such as a motor, an oil cylinder, or an air cylinder, or it may be manually operated. In some high-end application scenarios, a remote control or intelligent control system may also be provided to realize remote or automatic adjustment functions.

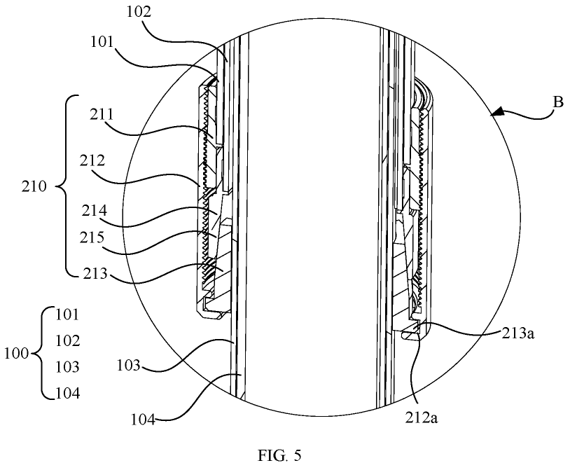

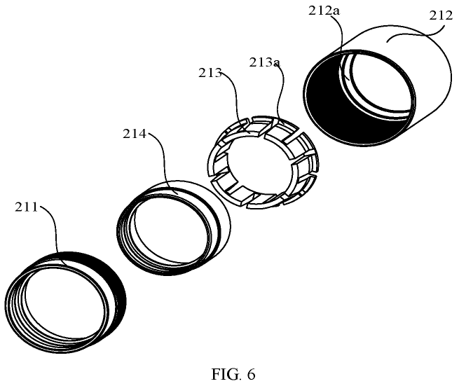

With continued reference to FIGS. 5 and 6, in the present embodiment, an outer wall of the first connecting member 211 is provided with external threads, an inner wall of the locking sleeve 212 is arranged with internal threads configured to engage with the external threads, and the locking sleeve 212 is threadedly connected to the first connecting member 211 via engagement of the external threads and the internal threads. The threaded connection structure enables the locking sleeve 212 to perform precise axial movement relative to the first connecting member 211, thereby realizing fine adjustment of the locking degree.

By applying an external fore to rotate the locking sleeve 212, the locking sleeve 212 can drive the first abutting portion 213 to move in an axial direction under the action of the screw pair. For example, when the locking sleeve 212 rotates clockwise, the locking sleeve 212 moves as a whole toward the first connecting member 211, causing the first abutting portion 213 located at the other end of the locking sleeve 212 to advance inward, increasing the pressing force of the first abutting portion 213 on the outer wall of the second inner tube 103. At the same time, the gap 215 between the outer wall of the first abutting portion 213 and the inner wall of the locking sleeve 212 is reduced, generating a greater wedge locking force on the side wall of the second connecting member 214 inserted into the gap 215.

In this way, the rotation angle of the locking sleeve 212 directly determines the extent to which the first abutting portion 213 extends between the second connecting member 214 and the second inner tube 103, thereby realizing continuous and precise adjustment of the locking force. Users can select an appropriate locking force according to actual load requirements, which not only ensures a sufficient locking effect but also avoids component damage caused by excessive locking.

In the present embodiment, the external threads and the internal threads may adopt standard metric threads with a designed pitch of 1.5 millimeter, which enables an axial displacement of 1.5 millimeter for the locking sleeve 212 per full rotation, facilitating precise control by the user. In consideration of anti-loosening performance, self-locking threads may be adopted, which can maintain the locked state without loosening in a vibration environment.

In addition, an outer surface of the locking sleeve 212 may be designed with anti-slip textures to increase friction with the user’s fingers, facilitating application of sufficient torque to complete the locking operation. The locking sleeve 212 may be made of wear-resistant nylon material, which not only has sufficient strength to withstand the locking force but also offers a certain degree of elasticity, allowing it to cushion vibrations when in the locked state.

The threaded locking structure of the present embodiment not only simplifies the locking operation, allowing the user to complete locking with a simple rotation, but also provides controllable locking force to adapt to support requirements of equipment with different weights, improving the applicability and user experience of the support assembly.

With continued reference to FIGS. 5 and 6, in the present embodiment, an outer wall of the first abutting portion 213 and an inner wall of the second connecting member 214 are both configured to be tapered.

In the present embodiment, the reason why the outer wall of the first abutting portion 213 and the inner wall of the second connecting member 214 are configured to be tapered is that tapered contact surfaces can significantly improve the locking effect and operational convenience. When the locking sleeve 212 rotates, the wedge force generated between the tapered surfaces is much greater than that between parallel surfaces, which enables a stronger locking effect under the same rotation torque.

For example, the taper of the outer wall of the first abutting portion 213 may be designed to be 3^{o} to 5^{o}, and the taper of the inner wall of the second connecting member 214 is matched therewith. The tapered surfaces move axially and press against each other to generate a radial component force. On the one hand, this radial component force makes the first abutting portion 213 abut against the outer wall of the second inner tube 103 more tightly; on the other hand, it also enhances the fixing effect between the second connecting member 214 and the first inner tube 102, forming a complete force transmission path.

The tapered contact surfaces also have a self-locking characteristic. Once locked, due to the friction and wedge effect between the tapered surfaces, loosening is not likely to occur even in a vibration environment, improving the reliability of locking. Furthermore, the tapered structure also provides a certain guiding function, making the locking operation smoother and reducing the risk of jamming.

In addition, the taper design can, to some certain extent, compensate for tolerances during manufacturing and assembly, improving product consistency and stability. Even after long-term use, if slight wear occurs on the contact surfaces, the tapered structure can still maintain effective locking performance, thereby prolonging the service life of the product.

With continued reference to FIGS. 5 and 6, in the present embodiment, an inner wall of the locking sleeve 212 is defined with an annular groove 212a, and the annular groove 212a is located at an end of the locking sleeve 212 remote from the second connecting member 214.

An end of the first abutting portion 213 remote from the second connecting member 214 is provided with a mounting protrusion 213a, and the mounting protrusion 213a is in clamping in the annular groove 212a.

In the present embodiment, the snap-fit structure between the annular groove 212a and the mounting protrusion 213a is provided to ensure that when adjusting the locking degree, the locking sleeve 212 rotates while the first abutting portion 213 does not follow the rotation but only moves axially. This structural design solves a common problem in conventional locking mechanisms: locking parts may generate relative torsional friction with the locked object during rotation, resulting in unstable locking or wear on the surface of the locked object.

The annular groove 212a is circumferentially distributed on the inner wall of the locking sleeve 212 to form a complete annular structure, and its axial width is slightly larger than the axial thickness of the mounting protrusion 213a to ensure that the mounting protrusion 213a can move axially to a limited extent within the annular groove 212a. The mounting protrusion 213a is designed as an annular structure matching the annular groove 212a, and the radial height of the protrusion is adapted to the radial depth of the annular groove 212a, ensuring that the two can be reliably snap-fitted and are not easily disengaged.

When a user rotates the locking sleeve 212, due to the threaded connection between the locking sleeve 212 and the first connecting member 211, the locking sleeve 212 moves axially. The engagement structure between the annular groove 212a and the mounting protrusion 213a allows the first abutting portion 213 to only move axially following the locking sleeve 212, without rotating together with the locking sleeve 212. This ensures that there is only pure axial relative movement between the first abutting portion 213 and the outer wall of the second inner tube 103, avoiding wear and instability caused by rotational friction.

In addition, such a engagement structure helps maintain the correct positioning and guidance of the first abutting portion 213, preventing it from tilting or skewing during use, ensuring that the abutting force is evenly distributed on the outer wall of the second inner tube 103, thereby improving the consistency and reliability of the locking effect.

To enhance the durability of the engagement structure, the contact surfaces of the annular groove 212a and the mounting protrusion 213a may be specially treated to improve wear resistance and lubricity. In addition, an appropriate gap is left between them to ensure that the first abutting portion 213 can move freely in an axial direction without excessive shaking, maintaining the stability of the overall structure.

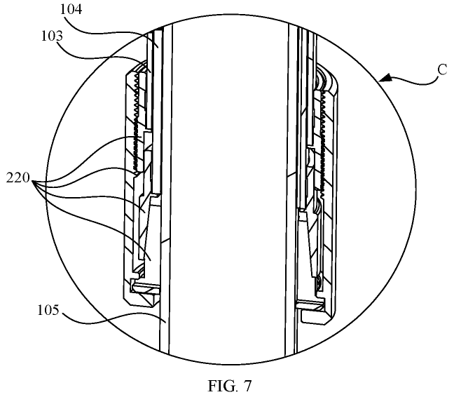

With reference to FIG. 7, in the present embodiment, the support assembly further includes a third inner tube 104 and a fourth inner tube 105, the third inner tube 104 is disposed within the second inner tube 103, and the fourth inner tube 105 is disposed within the third inner tube 104.

The dual-lock support assembly further includes a second locking assembly 220, the second locking assembly 220 is connected to one end of both the second inner tube 103 and the third inner tube 104 and is nested outside the fourth inner tube 105. The structure of the second locking assembly 220 is identical to that of the first locking assembly 210.

In the present embodiment, on the basis of the outer tube 101, the first inner tube 102, and the second inner tube 103 of the foregoing embodiments, a multi-stage telescopic structure is provided by adding the third inner tube 104 and the fourth inner tube 105, aiming to achieve a wider range of height adjustment capability. Such a multi-stage telescopic design allows the support assembly to achieve a higher working height after extension while maintaining a compact storage volume, meeting the requirements of more diverse usage scenarios. For example, in the field of photography, such a multi-stage support assembly can accommodate various shooting requirements, from low-angle macro shooting to high-angle overhead shooting.

The third inner tube 104 and the fourth inner tube 105 follow the design principle of the inner and outer tubes 101 in the foregoing embodiments, with appropriate gap left between each tube to ensure smooth sliding, while maintaining a sufficient contact area to guarantee structural stability. A graded material design may be adopted for the tubes, that is, materials with higher strength and lighter weight are sequentially used from the outer tube 101 to the innermost tube. For example, the outer tube 101 could be made of aluminum alloy, while the innermost tube could be made of carbon fiber composite material, reducing the overall weight while ensuring strength.

The second locking assembly 220 has the same structure as the first locking assembly 210, and also includes components such as a connecting member, a locking sleeve 212, and an abutting portion, adopting the same locking principle. The second locking assembly 220 is installed at the connection between the second inner tube 103 and the third inner tube 104 and is responsible for locking the third inner tube 104 and the fourth inner tube 105, forming a same dual-locking effect as the first locking assembly 210.

In some embodiments, the first locking assembly 210 and the second locking assembly 220 may operate in linkage to realize one-touch locking or one-touch unlocking of multiple tubes.

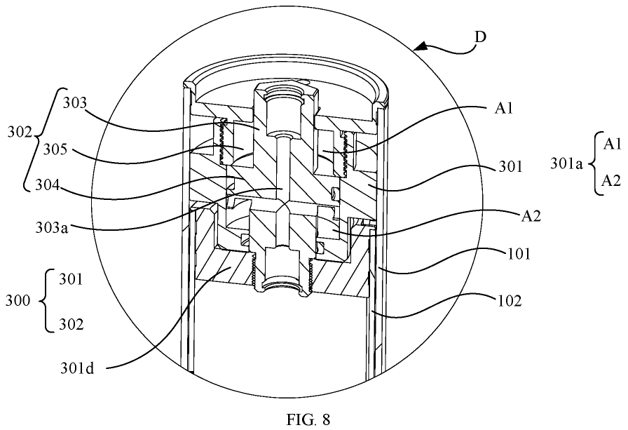

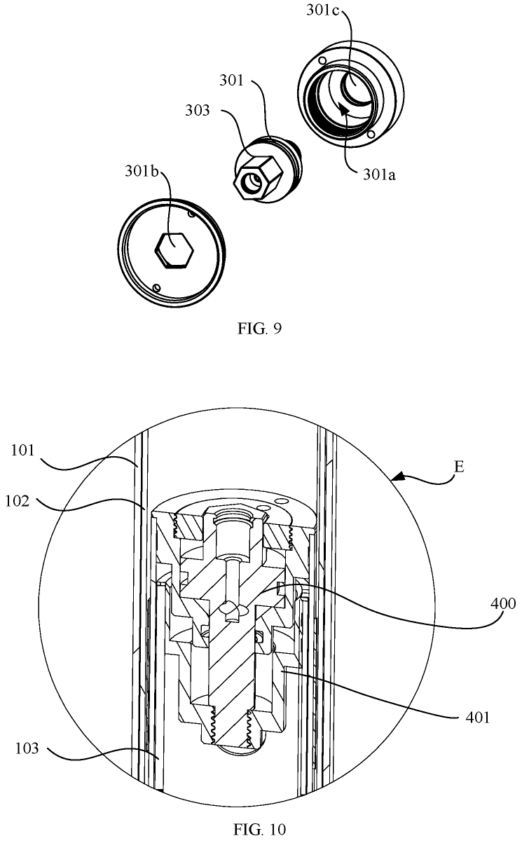

With reference to FIGS. 8 and 9, in the present embodiment, the dual-lock support assembly further includes a first driving assembly 300, and the first driving assembly 300 is disposed at the other end of the outer tube 101. An execution end 301d of the first driving assembly 300 extends into the outer tube 101 and is connected to the other end of the second inner tube 103.

The first driving assembly 300 includes a mounting shell 301 and a piston assembly 302.

The mounting shell 301 defines a first cavity 301a having a first opening 301b and a second opening 301c located at two ends of the first cavity 301a, and both the first opening 301b and the second opening 301c are in communication with the first cavity 301a.

The piston assembly 302 is disposed within the first cavity 301a.

The piston assembly 302 includes a piston rod 303, and the piston rod 303 sequentially passes through the first opening 301b, the first cavity 301a, and the second opening 301c. A partition member 304 is provided on an outer peripheral wall of the piston rod 303 to divide the first cavity 301a into at least two chambers.

A fluid channel 303a is defined inside the piston rod 303, with one end communicated with the outside and the other end extended into a side wall of the piston rod 303 and communicated with one of the at least two chambers (e.g., the first chamber A1, the second chamber A2).

In the present embodiment, a fluid-driven mechanism is introduced to realize power assistance for the locking and unlocking processes, improving operational convenience and control accuracy.

The first driving assembly 300 includes the mounting shell 301 and the piston assembly 302. The mounting shell 301 has the first cavity 301a, with the first opening 301b and the second opening 301c respectively provided at two ends of the first cavity 301a. Both the first opening 301b and the second opening 301c are in communication with the first cavity 301a, forming a space for fluid operation. The piston assembly 302 is disposed within the first cavity 301a and includes the piston rod 303, and the piston rod 303 sequentially passes through the first opening 301b, the first cavity 301a, and the second opening 301c. A partition member 304, typically a sealing ring or a piston head, is provided on an outer peripheral wall of the piston rod 303 for dividing the first cavity 301a into at least two chambers. The fluid channel 303a is defined inside the piston rod 303, one end of the fluid channel 303a is in communication with the outside, and the other end passes through the side wall of the piston rod 303 and is in communication with one of the at least two chambers. In the present embodiment, the fluid channel 303a is in communication with the second chamber A2.

In the present embodiment, fluid enters from the externally communicating end of the fluid channel 303a, flows through the fluid channel 303a inside the piston rod 303, and then enters the second chamber A2 from an opening passing through the side wall of the piston rod 303 at the other end. When the fluid enters the second chamber A2, the pressure increases, pushing the partition member 304 to generate a thrust force on the piston rod 303 in a first direction (e.g., upward). Since the piston rod 303 is fixedly connected to the second inner tube 103, this thrust force is transmitted to the second inner tube 103, causing the second inner tube 103 to rise, thereby pulling the second connecting member 214 out of the gap 215 between the locking sleeve 212 and the first abutting portion 213, so as to realize an unlocked state.

On the contrary, when locking is required, the fluid is controlled to flow back from the second chamber A2 or injected into the first chamber A1, generating a thrust force in a second direction (e.g., downward). This thrust force causes the second inner tube 103 to descend, driving the second connecting member 214 into the gap 215 between the locking sleeve 212 and the first abutting portion 213, so as to realize a locked state.

The fluid in the present embodiment may be hydraulic oil or gas, corresponding to hydraulic drive and pneumatic drive, respectively. Hydraulic drive provides greater output force and precise position control, suitable for scenarios carrying heavy equipment; pneumatic drive offers fast response speeds and a simple system, suitable for light-load scenarios requiring rapid adjustment.

In addition, in an embodiment with a multi-stage telescopic tube structure, the first driving assembly 300 may operate in linkage with the second driving assembly 400, simultaneously controlling multiple locking points through an integrated hydraulic or pneumatic system to realize one-button locking or unlocking. The control system may employ electronic valves and a microprocessor, supporting remote control and preset position memory functions, further improving operational convenience.

In the present embodiment, the fluid-driven locking system combines a conventional mechanical locking mechanism with a modern fluid power system, which not only retains the reliability of mechanical locking but also increases operational flexibility and convenience.

With continued reference to FIG. 8, in the present embodiment, the first driving assembly 300 further includes an elastic member 305, the elastic member 305 is mounted in the other one of the at least two chambers, and the elastic member 305 is configured to flexibly support the piston rod 303.

In the present embodiment, a mechanical elastic member is introduced to complement the fluid driving system, improving the reliability and responsiveness of the system.

The elastic member 305 may be mounted in the first chamber A1 to provide a reset thrust force for the piston rod 303. When the fluid pressure drives the piston rod 303 to move in the first direction to realize the unlocked state, the elastic member 305 is compressed and stores elastic potential energy. When the fluid pressure decreases or is released, the elastic member 305 releases the stored energy, pushing the piston rod 303 to move in the second direction, allowing the system to return to the locked state.

In the present embodiment, the elastic member 305 may be a metal coil spring, which has the advantages of simple structure, reliable performance, and low cost. Meanwhile, springs with different stiffnesses may be selected according to different load requirements to match different application scenarios. In addition to coil springs, the elastic member 305 may also be disc springs, wave springs, or polyurethane elastomers.

As such, the combination of the elastic reset mechanism and the fluid drive system forms a dual-protection mechanism of “dynamic active control and static passive insurance”, which not only facilitates users in precise height adjustment and locking control but also automatically ensures system safety under abnormal conditions.

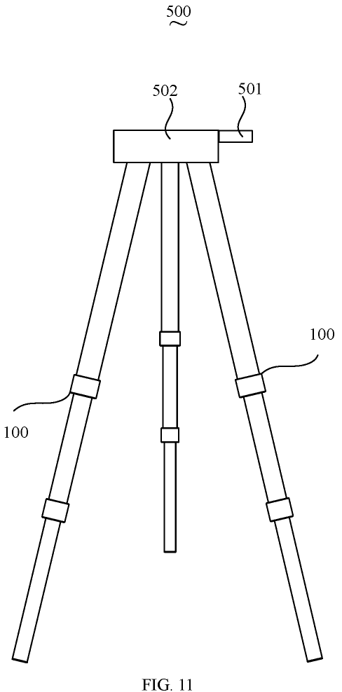

With reference to FIG. 10, in the present embodiment, the dual-lock support assembly further includes a second driving assembly 400. The second driving assembly 400 is disposed at the other end of the second inner tube 103, an execution end 401 of the second driving assembly 400 extends into the second inner tube 103 and is connected to the other end of the third inner tube 104, and the second driving assembly 400 is configured to drive the third inner tube 104 to move axially relative to the second inner tube 103.

The structure of the second driving assembly 400 is identical to that of the first driving assembly 300.

In the present embodiment, by adding the second driving assembly 400, the fluid-driven mechanism is extended to the multi-stage telescopic tube structure, realizing control of the third inner tube 104 and the fourth inner tube 105. The second driving assembly 400 follows the design concept of the first driving assembly 300, also including core components such as the mounting shell 301, the piston assembly 302, and the elastic member 305, and employing the same fluid drive principle. The second driving assembly 400 is installed at the end of the second inner tube 103, with its execution end 401 connected to the end of the third inner tube 104. By controlling the fluid pressure, the axial movement of the third inner tube 104 relative to the second inner tube 103 is realized, thereby controlling the locking state of the second locking assembly 220.

In the present embodiment, the first driving assembly 300 and the second driving assembly 400 can have their fluid passages communicated, thereby realizing a linkage function of one-button unlocking and one-button locking. The fluid channel of the first driving assembly 300 and the second driving assembly 400 may communicate with each other through connecting pipelines disposed in each inner tube, forming a fluid system. When pressurized fluid is introduced, the pressure can be simultaneously transmitted to the two driving assemblies, enabling them to work in coordination and act synchronously. Thus, the user only needs to operate a single control valve or button to simultaneously control the locking state of all inner tubes. For example, upon pressing the “unlock” button, the system injects pressurized fluid into the corresponding chambers of each driving assembly, synchronously pushing each piston rod 303 to move, thereby unlocking all locking assemblies simultaneously; conversely, releasing the pressure or applying pressure to the chamber in the opposite direction can realize synchronous locking of all locking assemblies.

In addition, the system can also be designed to support a single-stage control mode. By allowing user to switch the valve configuration, the user can choose to control only a specific level of the inner tubes, achieving more precise height adjustment. This flexibility is particularly suitable for professional application scenarios that require precise positioning.

The design of the multi-stage drive linkage mechanism not only simplifies user operation and improves adjustment efficiency, but also enhances the coordination and consistency of the entire support system, making the height adjustment process smoother and more controllable.

Further, in the present embodiment, both the first driving assembly 300 and the second driving assembly 400 are hydraulic cylinders, and the first driving assembly 300 and the second driving assembly 400 are connected via oil delivery hoses.

With reference to FIG. 11, the present disclosure further provides a photography support frame 500, including an operating component 501, a bearing base 502, and a plurality of support assemblies according to the foregoing embodiments. For the specific structure of the support assembly, reference is made to the above embodiments. Since the photography support frame adopts all the technical solutions of all the above embodiments, it at least has all the technical effects brought about by the technical solutions of the above embodiments, which will not be repeated herein. The bearing base 502 is connected to the telescopic tube assemblies of the plurality of support assemblies, and the bearing base 502 is configured to mount photographic equipment.

The operating component 501 is connected to both the first driving assembly 300 and the second driving assembly 400 of each support assembly, and the operating component 501 is configured to output a driving force to the first driving assembly 300 and the second driving assembly 400.

In the present embodiment, the bearing base 502 is connected to the telescopic tube assemblies 100 of the plurality of support assemblies to form a stable triangular support structure. The bearing base 502 may be made of high-strength aluminum alloy with anodized surface, featuring characteristics of lightweight and high rigidity. The bearing base 502 may be provided with standard 1/4-inch and 3/8-inch threaded interfaces, compatible with most photographic equipment on the market, including cameras, tripod heads, and video cameras. A bubble level may also be provided at the center of the bearing base 502 to assist the user in quickly adjusting the horizontal level of the support frame.

The operating component 501 is integrated on the side of the bearing base 502 to form a unified control center and is connected to the first driving assembly 300 and the second driving assembly 400 of each support assembly. The operating component 501 includes a fluid pressure control system and a human-machine interface, configured to output a driving force to the driving assemblies of each support assembly to realize control the height and locking state of the support assembly.

The control system may adopt a centralized design, including, for example, a micro pump, a set of solenoid valves, a microprocessor control unit, and a touch operation panel. Users can select an operation mode (full linkage or individual control), adjust the height, and control the locking state through the touch panel. In some embodiments, the system may support multiple preset height memory functions, allowing the user to save commonly used height settings and recall them with a single button, greatly improving work efficiency.

The above descriptions are only part or preferred embodiments of the present disclosure. Neither the text nor the drawings shall limit the scope of protection of the present disclosure. Any equivalent structural transformation made by using the contents of the description and drawings of the present disclosure under the overall concept of the present disclosure, or direct/indirect application in other related technical fields, shall be included within the scope of protection of the present disclosure.

What is claimed is:

1. A dual-lock support assembly, comprising:
a telescopic tube assembly, comprising:
an outer tube;
a first inner tube, disposed within the outer tube and being capable of sliding relative to the outer tube in an axial direction; and
a second inner tube, disposed within the first inner tube and being capable of sliding relative to the first inner tube in the axial direction;
a first locking assembly, comprising:
a first connecting member, connected to one end of the outer tube;
a locking sleeve, the locking sleeve comprising one end being sleeved with the first connecting member and another end being arranged with a first abutting portion, the first abutting portion being coaxially disposed within the locking sleeve, an inner wall of the first abutting portion being abutted against an outer wall of the second inner tube, and a gap being defined between an outer wall of the first abutting portion and an inner wall of the locking sleeve; and
a second connecting member, connected to one end of the first inner tube, and a side wall of the second connecting member being extended into the gap.

2. The dual-lock support assembly according to claim 1, wherein an outer wall of the first connecting member is arranged with external threads, an inner wall of the locking sleeve is arranged with internal threads configured to engage with the external threads, and the locking sleeve is threadedly connected to the first connecting member via engagement of the external threads and the internal threads.

3. The dual-lock support assembly according to claim 2, wherein an outer wall of the first abutting portion and an inner wall of the second connecting member are both configured to be tapered.

4. The dual-lock support assembly according to claim 2, wherein an inner wall of the locking sleeve defines an annular groove, the annular groove being located at an end of the locking sleeve remote from the second connecting member;
an end of the first abutting portion remote from the second connecting member is arranged with a mounting protrusion, the mounting protrusion being in clamped in the annular groove.

5. The dual-lock support assembly according to claim 1, further comprising:
a third inner tube, disposed within the second inner tube;
a fourth inner tube, disposed within the third inner tube; and
a second locking assembly, connected to one end of the second inner tube and one end of the third inner tube, and sleeved outside the fourth inner tube, wherein the second locking assembly is identical in structure to the first locking assembly.

6. The dual-lock support assembly according to claim 5, further comprising:
a first driving assembly, disposed at another end of the outer tube, the first driving assembly comprising an execution end being extended into the outer tube and connected to another end of the second inner tube;
the first driving assembly comprising:
a mounting shell, defining a first cavity with a first opening and a second opening, the first opening being defined at one end of the first cavity and the second opening being defined at another end of the first cavity, both the first opening and the second opening being communicated to the first cavity;
a piston assembly, disposed within the first cavity, the piston assembly comprising:
a piston rod, configured to pass through the first opening, the first cavity, and the second opening in sequence, an outer peripheral wall of the piston rod being provided with a partition member configured to divide the first cavity into at least two chambers;
wherein a fluid channel is defined inside the piston rod, one end of the fluid channel is communicated with the outside, and another end of the fluid channel extends into a side wall of the piston rod and communicates with one of the at least two chambers.

7. The dual-lock support assembly according to claim 6, wherein the first driving assembly further comprises an elastic member mounted in the other one of the at least two chambers, and the elastic member is configured to support the piston rod.

8. The dual-lock support assembly according to claim 6, further comprising:
a second driving assembly, disposed at another end of the second inner tube, the second driving assembly comprising an execution end being extended into the second inner tube and connected to another end of the third inner tube, the second driving assembly being configured to drive the third inner tube to move axially relative to the second inner tube;
wherein the second driving assembly is identical in structure to the first driving assembly.

9. The dual-lock support assembly according to claim 8, wherein both the first driving assembly and the second driving assembly are hydraulic cylinders, and the first driving assembly is connected to the second driving assembly via the fluid channel.

10. A photography support frame, comprising:
an operating component;
a bearing base; and
a plurality of dual-lock support assemblies according to claim 6, the bearing base being connected to the telescopic tube assemblies of the plurality of dual-lock support assemblies, the bearing base being configured to mount photographic equipment;
the operating component being connected to the first driving assembly of each dual-lock support assembly and configured to output driving force to the first driving assembly of each support assembly.

11. The photography support frame according to claim 10, wherein an outer wall of the first connecting member is arranged with external threads, an inner wall of the locking sleeve is arranged with internal threads configured to engage with the external threads, and the locking sleeve is threadedly connected to the first connecting member via engagement of the external threads and the internal threads.

12. The photography support frame according to claim 11, wherein both an outer wall of the first abutting portion and an inner wall of the second connecting member are configured to be tapered.

13. The photography support frame according to claim 11, wherein an inner wall of the locking sleeve defines an annular groove, the annular groove being located at
an end of the locking sleeve remote from the second connecting member;
an end of the first abutting portion remote from the second connecting member is arranged with a mounting protrusion, the mounting protrusion being in clamped with the annular groove.

14. The photography support frame according to claim 10, further comprising:
a third inner tube, disposed within the second inner tube;
a fourth inner tube, disposed within the third inner tube;
a second locking assembly, connected to one end of the second inner tube and one end of the third inner tube and nested outside the fourth inner tube, wherein the second locking assembly is identical in structure to the first locking assembly.

15. The photography support frame according to claim 10, wherein the first driving assembly further comprises an elastic member mounted in the other one of the at least two chambers, and the elastic member is configured to support the piston rod.

16. The photography support frame according to claim 10, wherein the dual-lock support assembly further comprises:
a second driving assembly, disposed at another end of the second inner tube, an execution end of the second driving assembly being extended into the second inner tube and connected to another end of the third inner tube, the second driving assembly is configured to drive the third inner tube to move axially relative to the second inner tube;
wherein the second driving assembly is identical in structure to the first driving assembly.

17. The photography support frame according to claim 16, wherein both the first driving assembly and the second driving assembly are hydraulic cylinders, and the first driving assembly is connected to the second driving assembly via a fluid channel.

18. The photography support frame according to claim 16, wherein the operating component is connected to the first driving assembly and the second driving assembly of each of the dual-lock support assemblies, the operating component is configured to output a driving force to the first driving assembly and the second driving assembly of each of the support assemblies.
